(19) United States
(12) Patent Application Publication
(10) Pub. No.: US 2019/0346672 A1
(43) Pub. Date: Nov. 14, 2019

(54) DISPLAY SCREEN MAGNIFIER

(71) Applicant: Manjit Dosanjh, Vancouver (CA)

(72) Inventor: Manjit Dosanjh, Vancouver (CA)

(21) Appl. No.: 15/976,859

(22) Filed: May 10, 2018

(51) Int. Cl. G02B 25/00; G02C 7/02; H04M 1/02

(52) U.S. Cl. CPC G02B 25/002; H04M 1/027; G02C 7/02

(57) ABSTRACT

A magnifier; the magnifier is configured for removable attachment to an electronic-device including a display-screen. The magnifier includes a lens and a fastener which is used to attach the lens to the electronic-device and over the display-screen such that a user can view the display-screen of the electronic-device through the lens. The magnifier is useful for enlarging an appearance of the display-screen so that the user can view the display-screen without having to wear glasses or contact lenses.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of electronic devices and more specifically relates to a magnifying means for attachment to an electronic device.

### 2. DESCRIPTION OF RELATED ART

An electronic visual display, informally a screen, is a display device for presentation of images, text, or video transmitted electronically, without producing a permanent record. Electronic visual displays include television sets, computer monitors, and digital signage. They are also ubiquitous in mobile computing applications like tablet computers, smartphones, and information appliances. Often people have a hard time reading a text printed on pages of a book, or a text displayed on displays of their devices such as mobile devices, laptops, computers, and the like. Whether needing to see who is calling via caller I.D. or wanting to check e-mail through the phone, the user is typically required to use spectacles or even corrective lenses and still have difficulty seeing the information on the screen. Thus, a suitable solution is desired.

U.S. Pub. No. 2015/0362736 to Dana Conrad Kowasic relates to a magnified screen cover protector for electronic devices. The described magnified screen cover protector for electronic devices includes a magnified surface layer with a top protective layer and a bottom adhesive layer. The invention magnifies the screen of an electronic device with diopter and/or magnification power ranges so that the user may comfortably use the electronic device without the aid of wearing prescription eyewear, contact lenses, reading glasses or other visual aids. The touch screen sensitivity and functionality of the electronic device is unaffected by the magnified screen cover protector, so usability of the electronic devices touch and sensitivity functions are not compromised.

The present invention's additional benefit is protecting the glass and/or plastic surface of an electronic devices main viewing screen from scarrings shattering, debris and breakage. Other embodiments of the magnified screen cover protector would include a three dimensional (3D) magnification layer for viewing text images, and video in a three dimensional (3D) visual simulation on an electronic devices screen.

### BRIEF SUMMARY OF THE INVENTION

In view of the foregoing disadvantages inherent in the known electronic devices art, the present disclosure provides a novel smartphone screen magnifier. The general purpose of the present disclosure, which will be described subsequently in greater detail, is to provide a magnifying-means for attachment to an electronic device and for magnifying a display screen of the electronic device in an efficient and effective manner

A magnifier is disclosed herein. The magnifier includes a lens which may include a front-surface and a rear-surface relative to an electronic-device when the magnifier may be attached to the electronic-device. The lens may be configured for placement over a display-screen of the electronic-device and include a magnifying-means configured to enlarge an appearance of the display-screen when the lens may be placed over the display-screen. Further, a fastener may be fixedly attached to the lens and configured to removably attach the lens to the electronic-device as desired.

A method of using magnifier is also disclosed herein. The method of using magnifier may comprise the steps of: providing the magnifier as above; attaching the magnifier to the electronic-device via the fastener; positioning the lens over the display-screen of the electronic-device; and viewing the display-screen of the electronic-device through the front-surface of the lens.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a smartphone screen magnifier, constructed and operative according to the teachings of the present disclosure.

FIG. 1 is a front perspective view of the magnifier during an ‘in-use’ condition, according to an embodiment of the disclosure.

FIG. 2 is a front perspective view of the magnifier of FIG. 1, according to an embodiment of the present disclosure.

FIG. 3A is a front perspective view of the magnifier of FIG. 1, according to an embodiment of the present disclosure.

FIG. 3B is a front perspective view of the magnifier of FIG. 1, according to an embodiment of the present disclosure.

FIG. 4 is a front perspective view of the magnifier of FIG. 1, according to an embodiment of the present disclosure.

FIG. 5A is a front perspective view of the magnifier of FIG. 1, according to an embodiment of the present disclosure.

FIG. 5B is a front perspective view of the magnifier of FIG. 1, according to an embodiment of the present disclosure.

FIG. 6 is a flow diagram illustrating a method of use for the magnifier, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electronic devices and more particularly to a smartphone screen magnifier as used to improve the magnifying means for attachment to an electronic device.

Generally, disclosed is a smartphone detachable magnifier or prescription lens for viewing text or smaller objects without the need of wearing prescription eyewear, contact lenses, reading glasses or other visual aids. The lens may be equal in size to a phone screen and can clip on to the phone, be attached by hook and loop fastener such as VELCRO® or by magnets or hinged to the case to move to the back or side of the phone when not needed. The detachable magnifier or prescription lens may be sized and configured for attachment to a plurality of differently sized smartphones. For example, flip/foldable cellphones, touchscreen phones, etc.

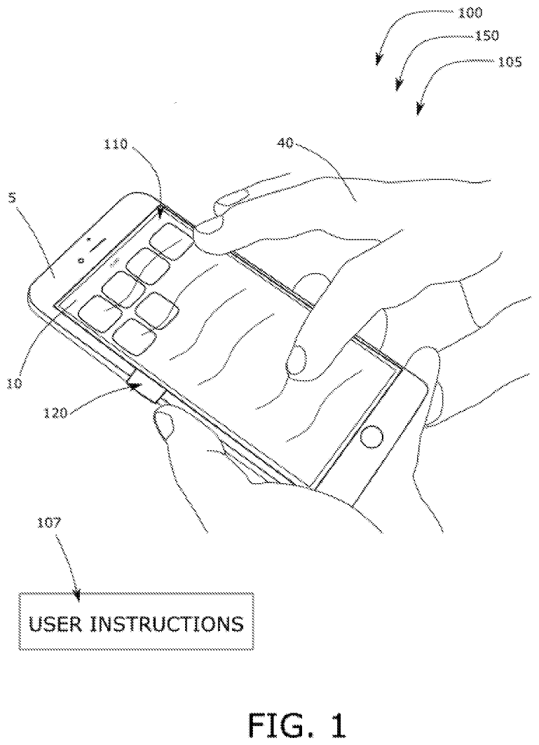

Referring now more specifically to the drawings by numerals of reference, there is shown in FIGS. 1-5B, various views of a magnifier 100.

FIG. 1 shows a magnifier 100 during an ‘in-use’ condition 150, according to an embodiment of the present disclosure. As Illustrated, the magnifier 100 may include a lens 110 and a fastener 120. As shown, the magnifier 100 may be for removable attachment to an electronic-device 5 including a display-screen 10.

According to one embodiment, the magnifier 100 may be arranged as a kit 105. The kit 105 may include set of user instructions 107. The instructions 107 may detail functional relationships in relation to the structure of the magnifier 100 (such that the magnifier 100 can be used, maintained, or the like, in a preferred manner).

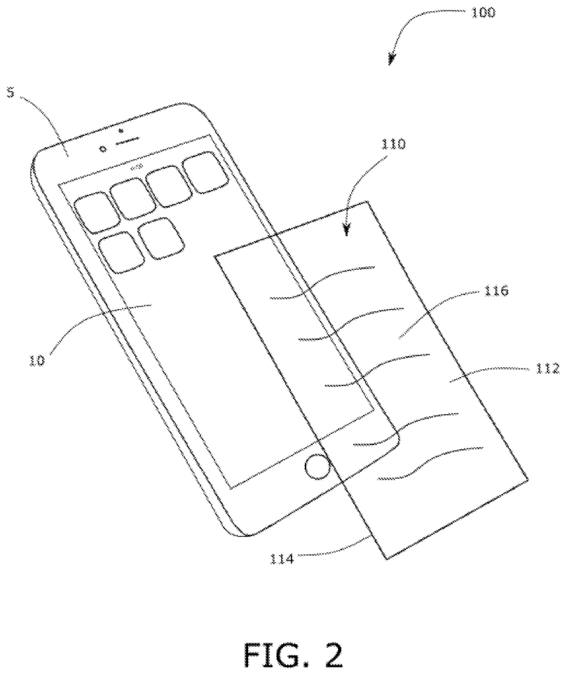

Referring now to FIG. 2 showing a front perspective view of the magnifier 100 of FIG. 1, according to an embodiment of the present disclosure. As shown, the lens 110 may include a front-surface 112 and a rear-surface 114 relative to the electronic-device 5 when the magnifier 100 is attached to the electronic-device 5. The lens 110 may be configured for placement over the display-screen 10 and as shown, the rear-surface 114 of the lens 110 may contact the display-screen 10 when placed.

Further, the lens 110 may include a magnifying-means 116 configured to enlarge an appearance of the display-screen 10 when the lens 110 is placed over the display-screen 10. In one embodiment, the magnifying-means 116 may include magnifying glass. In this embodiment, the magnifying glass may include a convex lens 110 and a magnifying power of the magnifying glass may vary depending on where it is placed between a user's eye and the display-screen 10, and the total distance between them. Further, in this embodiment, the magnifying glass may have a focal length of at least 25 cm, or 2× magnification. However, other strengths are contemplated. For example, the magnifying glass may be a Coddington magnifier 100 configured to provide magnification power as high as 20×, or a Hastings triplet magnifier 100 configured to provide a clearer image.

In another embodiment, the magnifying-means 116 may include a prescription lens 110. The prescription lens 110 may include a plurality of lens 110 strengths and may be customized to the user or standardized with lens 110 strengths that the user may choose. In the preferred embodiment, the prescription lens 110 power may be positive and configured to condense light and correct hyperopia/far-sightedness in the user, and in doing so, enlarge the appearance of the display-screen 10 to the user. In one embodiment, a lens-strength of the magnifying-means 116 may be at least 10 diopters. In another embodiment, the lens 110—strength may be at least 2 diopters. In addition to this, as above, the prescription lens 110 may include standardized length strengths ranging from 0.25-10 diopters. Higher strengths are also contemplated.

In one embodiment, the lens 110 may be flexible. In this embodiment, the lens 110 may be foldable and easily manipulated. This embodiment may be particularly useful for smartphone devices that are flip/foldable such that the user may close their smartphone whilst the magnifier 100 stays attached to the display-screen 10. The lens 110 may be sized to substantially cover the display-screen 10 of the electronic-device 5. This may be particularly true for the embodiment where the electronic-device 5 is the smartphone and the lens 110 sized to substantially cover the display-screen 10 smartphone. It should be appreciated that the size of the lens 110 may differ as new electronic-device 5 designs and styles are realized.

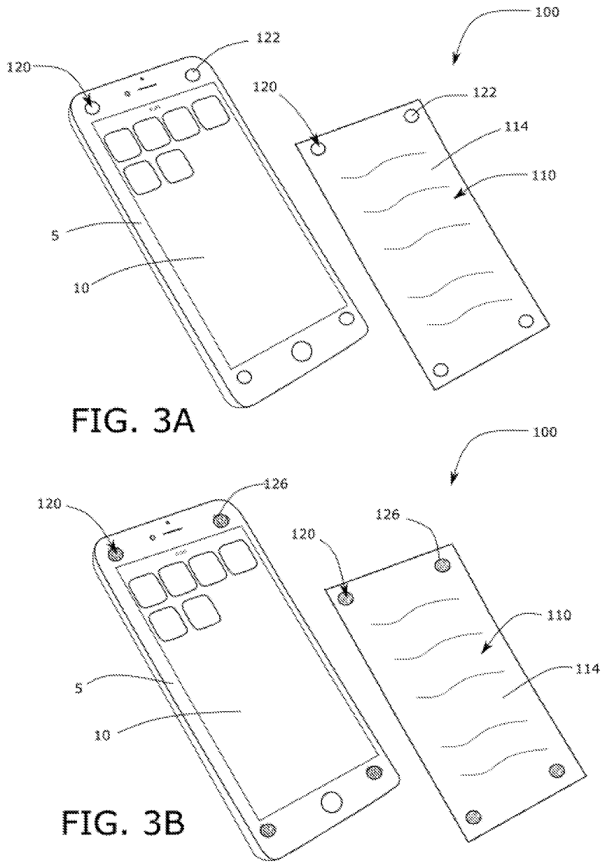

FIGS. 3A-3B show front perspective views of the magnifier 100 of FIG. 1, according to an embodiment of the present disclosure. The fastener 120 may be fixedly attached to the lens 110 and configured to removably attach the lens 110 to the electronic-device 5 as desired. As shown here, the fastener 120 may be a magnet 122 attached to the rear-surface 114 of the lens 110. In this embodiment, the fastener 120 may be one or more magnets 122 fixedly attached to the rear-surface 114 of the lens 110. The electronic-device 5 may include a magnetic-means configured to magnetically attach the rear-surface 114 of the lens 110 to the display-screen 10. Further, as shown, in another embodiment, the fastener 120 may be a hook and loop fastener 126 attached to the rear-surface 114 of the lens 110. The hook and loop fastener 126 contemplated may be VELCRO® and generally consisting of lineal fabric strips or patches attached to the rear-surface 114 of the lens 110 and on the electronic-device 5 to attach the lens 110 to the display-screen 10.

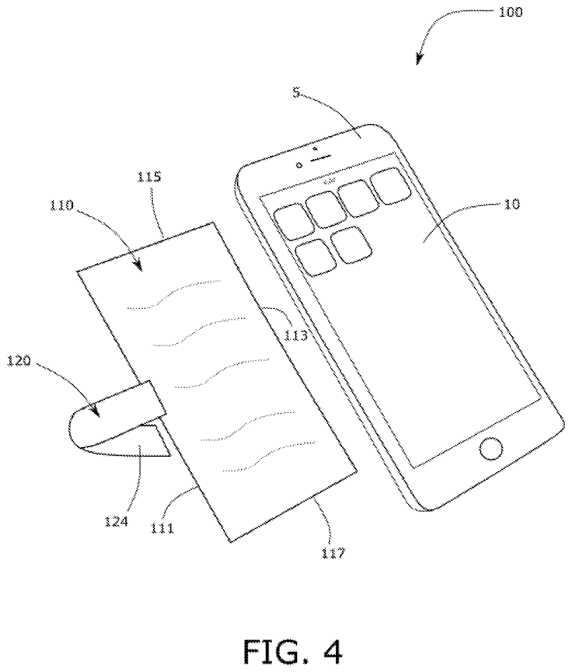

FIG. 4 shows a front perspective view of the magnifier 100 of FIG. 1, according to an embodiment of the present disclosure. As shown, the lens 110 may further include a lens left-edge 111, a lens right-edge 113, a lens top-edge 115 and a lens bottom-edge 117. In this embodiment, the fastener 120 may be a clip 124 attached to one of the lens left-edge 111, the lens right-edge 113, the lens top-edge 115 and alternately the lens bottom-edge 117 (in this figure it is shown to be attached to the lens left-edge 111). In the preferred embodiment, the clip 124 may be similar to a money clip 124 typically used to store cash, however, other clips 124 may be used. For example, a binder clip 124. The clip 124 may be made from plastic or silicone to prevent scratching of the lens 110 or the electronic-device 5. Alternatively, materials such as metal, titanium, carbon fiber, etc. may be used to provide durability.

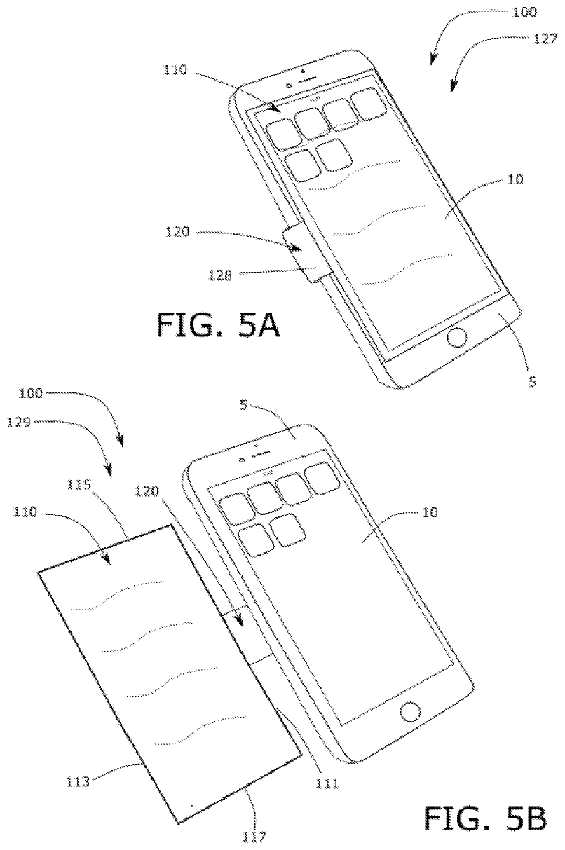

FIGS. 5A-5B show front perspective views of the magnifier 100 of FIG. 1, according to an embodiment of the present disclosure. In another embodiment, the fastener 120 may be a hinge 128 configured to hingedly attach the lens 110 to the electronic-device 5. Again, in this embodiment, the lens 110 may include the lens left-edge 111, the lens right-edge 113, the lens top-edge 115 and the lens bottom-edge 117 and the hinge 128 may be attached to one of the lens left-edge 111, the lens right-edge 113, the lens top-edge 115 and alternately the lens bottom-edge 117 (shown here to the lens left-edge 111).

In this embodiment, the lens 110 may be movable between an operative-position 127 and an inoperative-position 129 via the hinge 128 such that the user may remove the lens 110 from the display-screen 10 but not from the electronic-device 5. In this embodiment, the operative-position 127 may include the lens 110 being positioned over the display-screen 10 of the electronic-device 5 and the inoperative-position 129 may include the lens 110 being positioned away from the display-screen 10 of the electronic-device 5. For example, in one embodiment, the inoperative-position 129 may include the lens 110 being folded at a rear of the electronic-device 5 (the rear being opposite the display-screen 10). In another embodiment, the inoperative-position 129 may include the lens 110 being positioned to a side of the electronic-device 5.

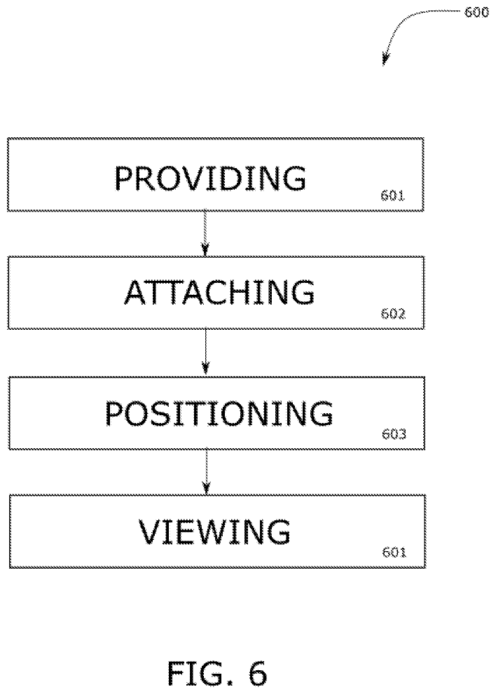

FIG. 6 is a flow diagram illustrating a method of using a magnifier for attachment to an electronic-device 600, according to an embodiment of the present disclosure. As illustrated, the method of using a magnifier for attachment to an electronic-device 600 may include the steps of: step one 601, providing the magnifier 100 as above; step two 602, attaching the magnifier 100 to the electronic-device 5 via the fastener 120; step three 603, positioning the lens 110 over the display-screen 10 of the electronic-device 5; and step four 604, viewing the display-screen 10 of the electronic-device 5 through the front-surface 112 of the lens 110.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for magnifier 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A magnifier for removable attachment to an electronic-device, the electronic-device including a display-screen, the magnifier comprising:
a lens including a front-surface and a rear-surface relative to the electronic-device when the magnifier is attached to the electronic-device, the lens being configured for placement over the display-screen and wherein the lens includes a magnifying-means configured to enlarge an appearance of the display-screen when the lens is placed over the display-screen; and
a fastener fixedly attached to the lens, and wherein the fastener is configured to removably attach the lens to the electronic-device as desired.

2. The magnifier of claim 1, herein the magnifying-means includes magnifying glass.

3. The magnifier of claim 1, wherein the magnifying-means includes a prescription lens.

4. The magnifier of claim 3, wherein the prescription lens includes a plurality of lens strengths.

5. The magnifier of claim 4, wherein the magnifying-means includes a lens-strength of at least 10 diopters.

6. The magnifier of claim 4, wherein the magnifying-means includes a lens-strength of at least 2 diopters.

7. The magnifier of claim 1, wherein the lens is flexible.

8. The magnifier of claim 1, wherein the electronic-device is a smartphone, and the lens is sized to substantially cover the display-screen of the smartphone.

9. The magnifier of claim 1, wherein the fastener is a magnet attached to the rear-surface of the lens.

10. The magnifier of claim 1, wherein the lens further includes a lens left-edge, a lens right-edge, a lens top-edge and a lens bottom-edge, and wherein the fastener is a clip attached to one of the lens left-edge, the lens right-edge, the lens top-edge and alternately the lens bottom-edge.

11. The magnifier of claim 1, wherein the fastener is a hook and loop fastener attached to the rear-surface of the lens.

12. The magnifier of claim 1, wherein the fastener is a hinge configured to hingedly attach the lens to the electronic-device.

13. The magnifier of claim 1, wherein the lens includes the lens left-edge, the lens right-edge, the lens top-edge and the lens bottom-edge, and wherein the hinge is attached to one of the lens left-edge, the lens right-edge, the lens top-edge and alternately the lens bottom-edge.

14. The magnifier of claim 13, wherein the lens is movable between an operative-position and an inoperative-position via the hinge.

15. The magnifier of claim 14, wherein the operative-position includes the lens being positioned over the display-screen of the electronic-device.

16. The magnifier of claim 15, wherein the inoperative-position includes the lens being positioned away from the display-screen of the electronic-device.

17. The magnifier of claim 16, wherein the inoperative-position further includes the lens being folded at a rear of the electronic-device, the rear being opposite the display-screen.

18. A magnifier for attachment to an electronic-device, the electronic-device including a display-screen, the magnifier comprising:
a lens including a front-surface and a rear-surface relative to the electronic-device when the magnifier is attachable to the electronic-device, the lens being configured for placement over the display-screen and wherein the lens includes a magnifying-means configured to enlarge an appearance of the display-screen when the lens is placeable over the display-screen; and
a fastener fixedly attached to the lens, and wherein the fastener is configured to removably attach the lens to the electronic-device; and
wherein the magnifying-means includes a lens-strength of at least 2 diopters;
wherein the electronic-device is a smartphone, and the lens is sized to substantially cover the display-screen of the smartphone when used;
wherein the lens further includes a lens left-edge, a lens right-edge, a lens top-edge and a lens bottom-edge;
wherein the fastener is a hinge configured to hingedly attach the lens to the electronic-device;
wherein the hinge is attached to one of the lens left-edge, the lens right-edge, the lens top-edge and alternately the lens bottom-edge;
wherein the lens is movable between an operative-position and an inoperative-position via the hinge;
wherein the operative-position includes the lens being positioned over the display-screen of the electronic-device;
wherein the inoperative-position includes the lens being positioned away from the display-screen of the electronic-device; and
wherein the inoperative-position further includes the lens being folded at a rear of the electronic-device, the rear being opposite the display-screen.

19. The magnifier of claim 18, further comprising set of instructions; and
wherein the magnifier is arranged as a kit.

20. A method of using a magnifier for attachment to an electronic-device, the electronic-device including a display-screen, the method comprising the steps of:
providing the magnifier for removable attachment to the electronic-device, the magnifier including:
a lens including a front-surface and a rear-surface relative to the electronic-device when the magnifier is attached to the electronic-device, the lens being configured for placement over the display-screen and wherein the lens includes a magnifying-means configured to enlarge an appearance of the display-screen when the lens is placed over the display-screen; and
a fastener fixedly attached to the lens, and wherein the fastener is configured to removably attach the lens to the electronic-device; and
attaching the magnifier to the electronic-device via the fastener;
positioning the lens over the display-screen of the electronic-device; and
viewing the display-screen of the electronic-device through the front-surface of the lens.
